(19) United States
(12) Patent Application Publication
(10) Pub. No.: US 2008/0100170 A1
(43) Pub. Date: May 1, 2008

(54) Carbon brush with wear-protecting means

(76) Inventors: Herbert Rehm, Puergen (DE); Stefan Dorner, Kaufbeuren (DE)

Correspondence Address: ABELMAN, FRAYNE & SCHWAB, 666 THIRD AVENUE, 10TH FLOOR, NEW YORK, NY, 10017, US

(21) Appl. No.: 11/904,788

(22) Filed: Sep. 27, 2007

(30) Foreign Application Priority Data
Sep. 29, 2006 (DE) 10 2006 000 496.5

(51) Int. Cl. H01R 39/27; H01R 39/26

(52) U.S. Cl. 310/251; 310/253

(57) ABSTRACT

A carbon brush (2) has an end contacting side (4) and an end application side (10) remote of the latter, and four side surfaces (8a, 8b, 8c, 8d), wherein wear-protecting means are arranged at an end area (24) facing the end application side (10). The wear-protecting means are formed as a cup-shaped protective cap (14).

### BACKGROUND OF THE INVENTION

1. Field of the Invention

The invention relates to a carbon brush of a universal motor which has an end contacting side for contacting a commutator and an end application side remote of the latter to which a spring pressure, for example, is applied in order to bias the carbon brush in direction of the commutator. Further, the carbon brush has four side surfaces extending between the end contacting side and the end application side. The wear-protecting means are arranged at an end area of the carbon brush facing the end application side.

2. Description of the Prior Art

In carbon brushes of the type mentioned above, lateral wear at the carbon brushes can be appreciably reduced by wear-protecting means. This wear occurs during operation due to the presence of dissolved carbon particles and the vibrations particularly between the side surfaces and the respective carbon guide. The lateral wear can lead to inaccurate guiding of the carbon brush in the carbon guide and, therefore, to a sharply curtailed life of the carbon brush.

GB 27,162 discloses a carbon brush in which protective plates are provided at two oppositely located side surfaces at the end area facing the end application side. These protective plates are connected to one another by two rivets which penetrate the carbon brush.

The known wear-protecting means are disadvantageous in that their fastening to the carbon brush is relatively uneconomical so that the manufacturing costs for the carbon brushes are relatively high. In addition, the manner of fastening causes a weakening of the material of the carbon brush which increases as a result of wear over the life of the carbon brush. This can lead in turn to wear of the carbon brush at the protective plates.

### SUMMARY OF THE INVENTION

It is the object of the present invention to eliminate the above-mentioned disadvantages in a carbon brush and to ensure sufficient protection against wear with low production costs.

This and other objects of the present invention, which will become apparent hereinafter, are achieved, according to the invention, in that the wear-protecting means are formed on a cup-shaped protective cap. A protective cap of this kind can be placed on the respective carbon brush in a simple manner and accordingly enables an economical manufacture of the carbon brush.

In a particularly preferred embodiment of the present invention, the protective cap substantially completely encloses all four side surfaces of the carbon brush. In this way, a circumferential stress which secures the protective cap on the carbon brush can be generated when the protective cap is suitably dimensioned in relation to the carbon brush.

A circumferential recess is advantageously provided at the four side surfaces in the end area facing the end application side for partially receiving the protective cap. In this way, the protective cap can be exactly formlockingly positioned with respect to the carbon brush.

At each side surface, the recess preferably has a thickness which corresponds to a thickness of a side wall of the protective cap facing the respective side surface. In this way, the surface of the protective cap terminates flush with the side surfaces of the carbon brush to ensure exact guidance along the carbon guide.

A receiving slot which opens in direction of a receiving opening of the protective cap is advantageously provided at one of the side walls. In this way, the protective cap can easily be pushed along a wire exiting laterally at the carbon brush. Further, a certain elasticity of the protective cap is produced by a receiving slot of the kind mentioned above enabling a particularly simple assembly.

Further, it is particularly advantageous when an adhesive is provided at the side surfaces between these side surfaces and the protective cap. In this way, the protective cap is secured to the carbon brush in a particularly stable manner.

In addition, the protective cap is advantageously made of polyamide 6.6 so that it can be ensured that the wear-protecting means are sufficiently resistant to abrasion.

### BRIEF DESCRIPTION OF THE DRAWINGS

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

The drawings show:

FIG. 1 a perspective view of an end contacting side of a carbon brush with detached protective cap; and

FIG. 2 a perspective view of an end application side of the carbon brush in direction II in FIG. 1.

### DETAILED DESCRIPTION OF THE PREFERRED EMBODIMENT

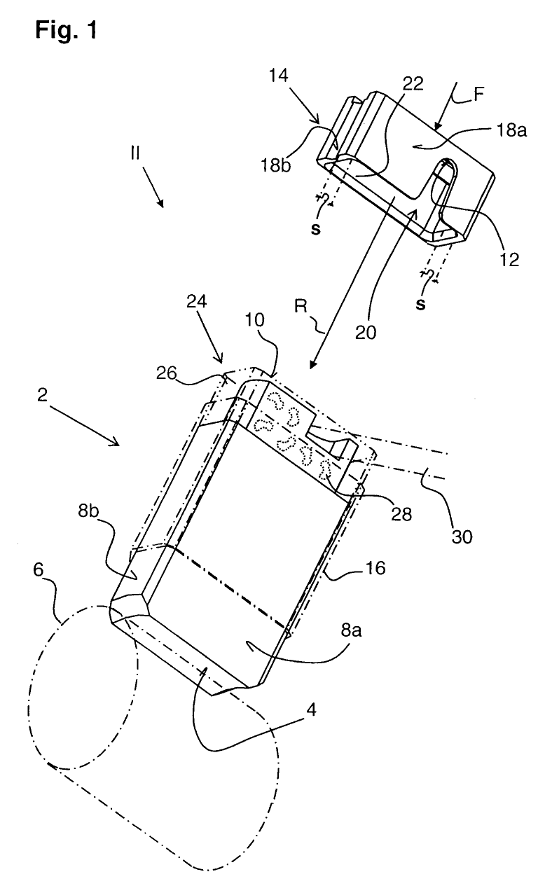

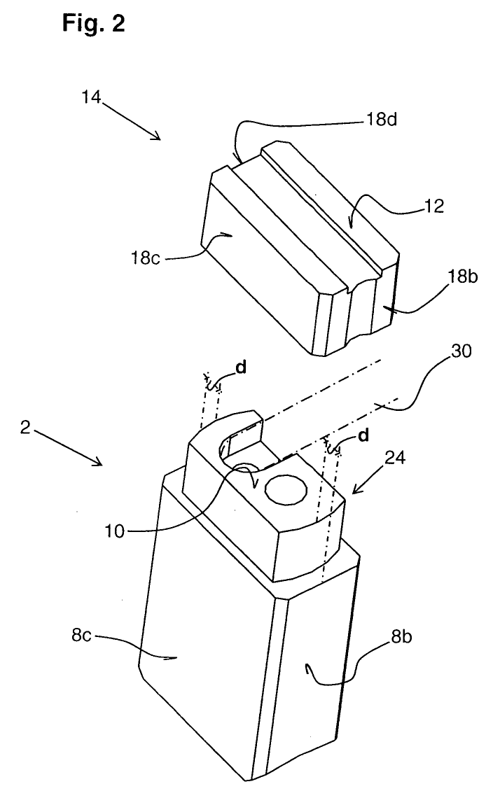

FIGS. 1 and 2 show a carbon brush 2 of a universal motor, not shown. This carbon brush 2 has an end contacting side 4 which contacts a commutator 6 of the universal motor during operation. Further, the carbon brush 2 has four side surfaces 8a, 8b, 8c, 8d and an end application side 10 which is acted upon by a contact pressing force F during operation with the intermediary of a base 12 of a cup-shaped protective cap 14. The carbon brush 2 is biased toward the commutator 6 along a carbon guide 16 by means of this contact pressing force F.

The cup-shaped protective cap 14 is made, for example, of polyamide 6.6 and has four side walls 18a, 18b, 18c, 18d proceeding from the base 12 which define a receptacle 20 with a receiving opening 22 arranged at one side of the protective cap 14 remote of the base 12. When the protective cap 14 is fitted on, an end area 24 of the carbon brush 2 facing the end application side 10 is inserted into the receptacle 20 by way of this receiving opening 22. The end area 24 has a slightly larger cross section than the receptacle 20. Accordingly, the protective cap which has a certain elasticity is clamped to the end area 24 by the circumferential stress which is generated when the protective cap is fitted on.

The side walls 18a, 18b, 18c, 18d and the base 12 function as wear-protecting means. In this respect, the side walls 18a, 18b, 18c, 18d reduce the abrasion which is caused at the end area 24 by friction at the carbon guide and which occurs particularly as a result of vibrations caused in operation when carbon dust and dissolved carbon particles are present.

In order to achieve a sufficiently stable connection between the protective cap 14 and the carbon brush 2 and to achieve a closed shaped of the protective cap 14 and carbon brush 2, a recess 26 is provided at the end area 24. This recess 26 is cut out circumferentially over the four side walls 8a, 8b, 8c, 8d and is formed relative to an original shape shown by a dash-dot line in FIG. 1. At each of the four side surfaces 8a, 8b, 8c, 8d, the recess 26 has a thickness d corresponding to a thickness s of the respective associated side walls 18a, 18b, 18c, 18d. Accordingly, the side surfaces 8a, 8b, 8c, 8d of the carbon brush terminate flush with the side walls 18a, 18b, 18c, 18d of the protective cap 14.

Further, a receiving slot 28 is cut out at the side wall 18a, which receiving slot 28 is formed parallel to a fitting direction R and opens toward the receiving opening 20. The protective cap 14 can also be fitted on the end area 24 by means of a wire 30 exiting laterally at the carbon brush 2.

An adhesive 32 producing an additional, adhesive connection can be provided at the end area 24 in addition to the above-mentioned clamping connection to further increase the stability of the connection between the carbon brush 2 and the protective cap 14.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A carbon brush (2), comprising an end contacting side (4) and an end application side (10) remote from the end contacting side (4); four side surfaces (8a, 8b, 8c, 8d); and wear-protecting means arranged at an end area (24) facing the end application side (10) and formed as a cup-shaped protective cap (14).

2. A carbon brush according to claim 1, wherein the protective cap (14) extends circumferentially along all four side surfaces (8a, 8b, 8c, 8d).

3. A carbon brush according to claim 1, wherein a circumferential recess (26) is provided at the four side surfaces (8a, 8b, 8c, 8d) in an end area (24) facing the end application side (10) for partially receiving the protective cap (14).

4. A carbon brush according to claim 3, wherein the recess (26) has at each side surface (8a, 8b, 8c, 8d) a thickness (d) which corresponds to a thickness (s) of a side wall (18a, 18b, 18c, 18d) of the protective cap (14) facing the respective side surface (8a, 8b, 8c, 8d).

5. A carbon brush according to claim 3, wherein a receiving slot (28) which opens in direction of a receiving opening (22) of the protective cap (14) is provided at one of the side walls (8a, 8b, 8c, 8d).

6. A carbon brush according to claim 1, wherein an adhesive (32) is provided at the side surfaces (8a, 8b, 8c, 8d) between these side surfaces (8a, 8b, 8c, 8d) and the protective cap (14).

7. A carbon brush according to claims 1, characterized in that the protective cap (14) is made of polyamide 6.6.
